(19) United States
(12) Patent Application Publication
(10) Pub. No.: US 2018/0116773 A1
(43) Pub. Date: May 3, 2018

(54) CUSTOM-MADE ORAL HYGIENE DEVICE FOR DAILY TEETH CLEANING AND POLISHING

(71) Applicants: YONG CHEN, La Canada, CA (US); NICHOLAS FU, LA PALMA, CA (US); SHAUN XUN XU, ALHAMBRA, CA (US)

(72) Inventors: YONG CHEN, La Canada, CA (US); NICHOLAS FU, LA PALMA, CA (US); SHAUN XUN XU, ALHAMBRA, CA (US)

(21) Appl. No.: 15/793,349

(22) Filed: Oct. 25, 2017

Related U.S. Application Data
(60) Provisional application No. 62/414,550, filed on Oct. 28, 2016.

(51) Int. Cl. A61C 17/02; A61C 9/00

(52) U.S. Cl. CPC A61C 17/0211; A61C 9/0046

(57) ABSTRACT

A custom dental irrigation device has: a user dentition model; a custom made mouthpiece made according to the user dentition model, a pump configured to pump fluid to the mouthpiece; a suction pump configured to remove fluid from the mouthpiece; a fluid tank; and a controller. The custom made mouthpiece is configured to deliver fluid to the dental target while removing used irrigation fluid. The mouthpiece is fabricated with 3-D print techniques. The mouthpiece is designed in two pieces to cover an upper portion of a dental target and a lower portion of a dental target separately. The mouthpiece has an inner surface following the shape of the user dentition model, wherein the inner surface touches the gingiva tissue to form a sealed space once the mouthpiece is set in a user's mouth, whereby fluid is delivered to the dental target, and removed from the sealed space.

The present invention is a non-provisional application of U.S. provisional application 62/414,550 filed Oct. 28, 2016, by same inventors Yong Chen, Nicholas Fu, Xun Xu, entitled Custom-made Oral Hygiene Device for Daily Teeth Cleaning and Polishing, the disclosure of which is incorporated herein by reference.

### FIELD OF THE INVENTION

The present invention relates generally to dental hygiene apparatus, and more specifically to customized dental irrigation device, which can minimize human input during routine daily plaques control process.

### DISCUSSION OF RELATED ART

Periodontal disease due to plaque accumulation is a major cause of dental disease. Removal of dental plaque is key to prevent dental decay and periodontal disease. Toothbrushes and floss have traditionally maintained oral hygiene. A dental water pick is also be an effective measure against periodontal diseases. However, many of the traditional tools require human input to have consistent and desirable results. Certain surfaces are not as well kept over time even for the most meticulous individuals. In addition, human error could cause soft tissue damage when not using the above mentioned tooth cleaning tools.

A variety of different patents describe dental irrigation devices using a mouthpiece U.S. Pat. No. 3,731,675 by inventor James Kelly patented May 8, 1973 entitled Dental Cleaning Apparatus, the disclosure of which is incorporated herein by reference. Additionally, U.S. Pat. No. 7,118,377 to inventor Inoue et al., patented Oct. 10, 2006 entitled Dental System And Method Of Producing The Same describes a dental cleaning system, the disclosure of which is incorporated herein by reference. Also, U.S. Pat. No 6,893,259 to inventor Reizenson issued May 17, 2005 entitled Oral Hygiene Device And Method For Use Therefor provides a combination four cleansing teeth, the disclosure of which is incorporated herein by reference.

The effectiveness of these mouthpiece devices is questionable due to the difficulty of applying irrigation with enough pulsation and pressure to all the tooth surfaces with plaque. Because of complex surface topography, applying water or solution with pulsation and pressure to all tooth surfaces remains problematic.

### SUMMARY OF THE INVENTION

It is the goal of the present invention to provide a custom-designed irrigation device based on the digital model of a patient's teeth. Further the device is fabricated using 3D-printing. The objective of present invention is to provide a user with a custom-made, hands-free oral hygiene device, which overcomes the above-mentioned disadvantages of other oral hygiene systems. In a preferred embodiment, the present invention is formed by a customized mouthpiece, delivery tube, collection tube, pump and suction unit, water tank, and electronic control unit. The custom-made oral hygiene device can be for daily teeth cleaning and polishing. A custom dental irrigation device has: a user dentition model; a custom made mouthpiece made according to the user dentition model, a pump configured to pump fluid to the mouthpiece; a suction pump configured to remove fluid from the mouthpiece; a fluid tank; and a controller. The custom made mouthpiece is configured to deliver fluid to the dental target while removing used irrigation fluid. The mouthpiece is fabricated with 3-D print techniques. The mouthpiece is designed in two pieces to cover an upper portion of a dental target and a lower portion of a dental target separately. The mouthpiece has an inner surface following the shape of the user dentition model, wherein the inner surface touches the gingiva tissue to form a sealed space once the mouthpiece is set in a user's mouth, whereby fluid is delivered to the dental target, and removed from the sealed space.

The occlusal stop formed on an inner surface of the mouthpiece stabilizes the mouthpiece. The mouthpiece has a pump tube for delivering fluid and a suction tube for removing fluid. The pump tube is connected to a manifold chamber having a manifold hollow. The mouthpiece has an outside spray conduit delivering water to a sealed space. The mouthpiece has an inside spray conduit delivering water to the sealed space. The mouthpiece has an outside exit conduit between the inside spray conduit and the outside spray conduit. The outside exit conduit is configured for removing water from the sealed space.

The inside spray conduit openings are formed in fluid communication with the inside spray conduit including: an inside spray conduit bottom opening; an inside spray conduit middle opening; and an inside spray conduit top opening. The plurality of inside spray conduit openings are disposed on a generally vertical inner surface of the mouthpiece body. The plurality of inside spray conduit openings formed in fluid communication with the inside spray conduit include: an inside spray conduit first sulcus opening, and inside spray conduit second sulcus opening, an inside spray conduit third sulcus opening, and an inside spray conduit cusp opening.

The plurality of outside spray conduit openings are formed in fluid communication with the outside spray conduit, and disposed on a generally vertical inner surface of the mouthpiece body. The outside spray conduits include: an outside spray conduit lower opening row; an outside spray conduit middle opening row; and an outside spray conduit upper opening row.

A method for irrigating a dental target includes the steps of: deriving a user dentition model from a dental target; forming a customized mouthpiece for the individual using the user dentition model; and printing the customized mouthpiece on a 3-D printer. The user dentition model is a three-dimensional (3D) model of the dental target. The customized mouthpiece has a pump tube for delivering fluid and a suction tube for removing fluid. The pump tube is connected to a manifold chamber having a manifold hollow. The opening orifices are based on topographies of the teeth represented in the user dentition model.

The method of obtaining the user dentition model involves the step of taking digital impressions of the dental target. The user and dentition model can also be accomplished by taking plaster casts of the dental target. The customized mouthpiece has an outside exit conduit formed at a cusp of the user dentition model. The outside exit conduit is formed between an outside spray conduit and an inside spray conduit. The outside exit conduit has an outside exit conduit opening formed proximate to a cusp of the user dentition model.

The customized mouthpiece has an outside exit conduit formed at an incisal edge of the user dentition model. The outside exit conduit is formed between an outside spray conduit and an inside spray conduit. The customized mouthpiece further includes at least one occlusal stop. The occlusal stops include: placing at least one occlusal stop on a functional cusp of a posterior tooth of the dentition model; and placing at least one occlusal stop on an anterior incisal edge of a tooth of the dentition model. The location of the occlusal stops can be generated and placed automatically by software based on the user dentition model. The 3-D printer is preferably a Stereolithography (SLA) 3D printer.

### BRIEF DESCRIPTION OF THE DRAWINGS

FIG. 1 is a cross-section diagram of the present invention mouthpiece.

FIG. 2 is a bottom perspective view of the present invention showing the relationship between the user dentition model and the mouthpiece in a test fit.

FIG. 3 is a side perspective view of the mouthpiece.

FIG. 4 is a cross-section view of the mouthpiece taken from FIG. 3 showing the inlet and outlet conduits.

FIG. 5 is a rear perspective view of the mouthpiece.

FIG. 6 is a section view of the mouthpiece taken from FIG. 5 showing the inlet and outlet conduits.

FIG. 7 is a front section view of the inlet conduits and spray nozzles.

FIG. 8 is a front perspective view.

FIG. 9 is a cross-section view of the spray nozzles.

FIG. 10 is a perspective view of the mouthpiece.

FIG. 11 is a section view of the inlet conduit.

FIG. 12 is a perspective view of the mouthpiece.

FIG. 13 is a section view of the mouthpiece showing the inlet pipe.

FIG. 14 is a perspective view of the mouthpiece.

FIG. 15 is a section view of the outlet conduit of the mouthpiece.

FIG. 16 is a perspective view of the mouthpiece.

FIG. 17 is a perpendicular section plane of the inlet and outlet conduits.

FIG. 18 is a perspective view of the mouthpiece showing a seal.

FIG. 19 is a diagram of the present invention including the custom mouthpiece, the pump controller and the pump volume controller.

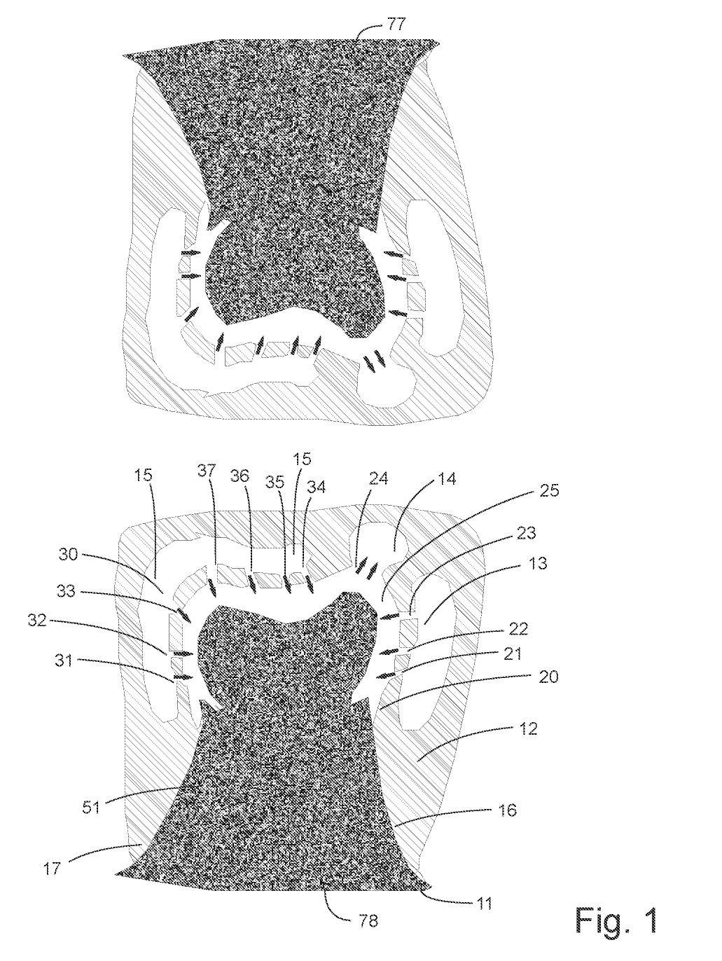

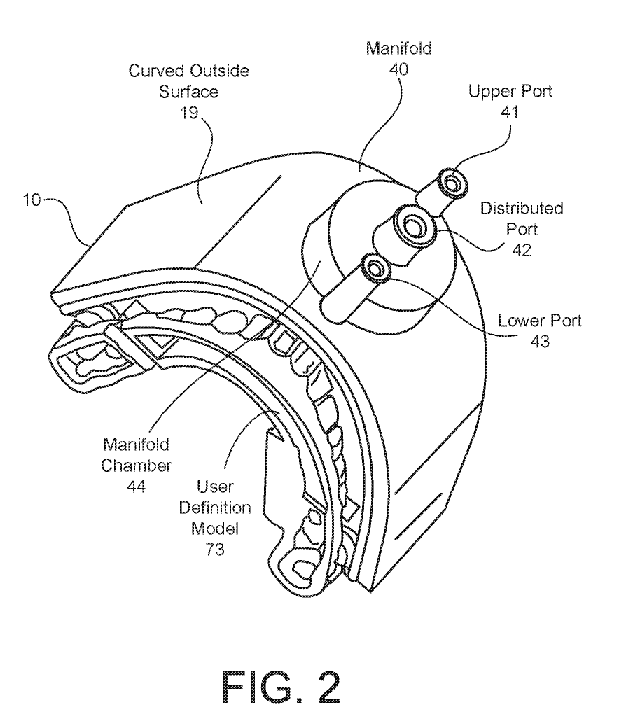

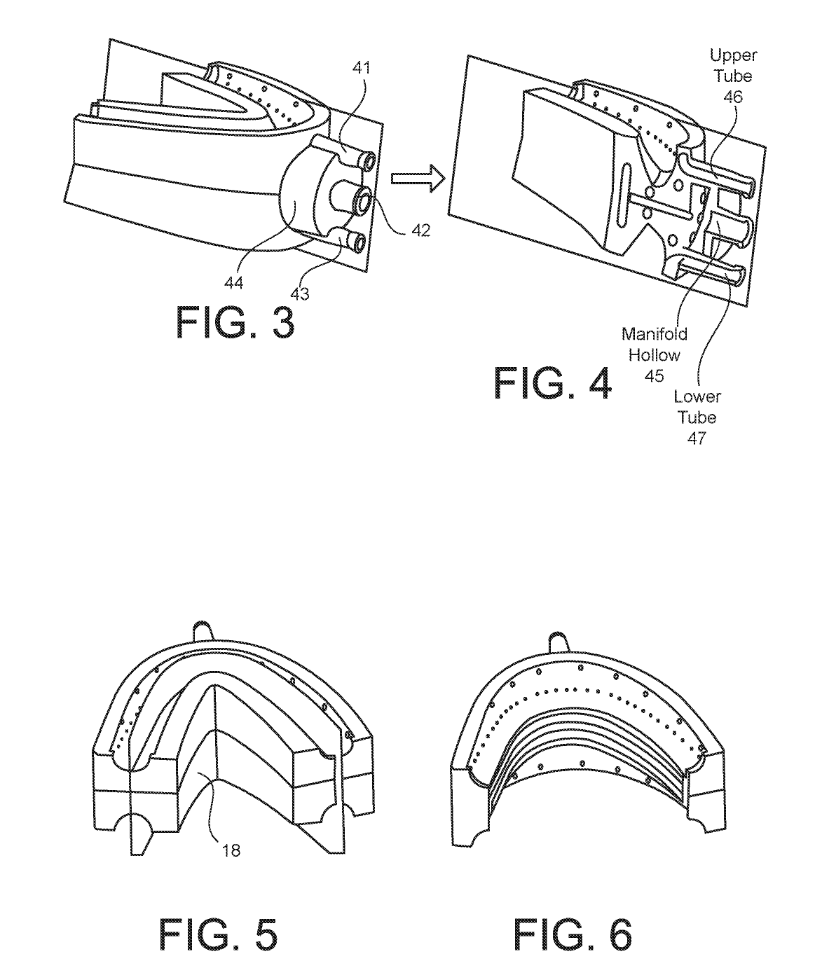

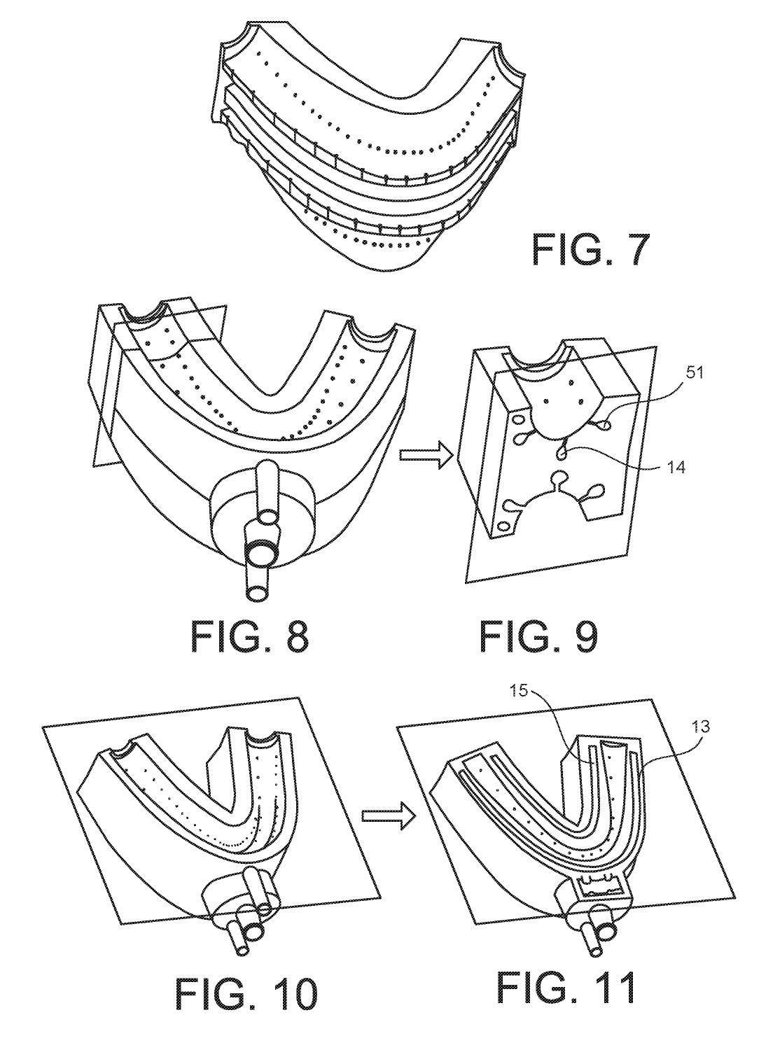

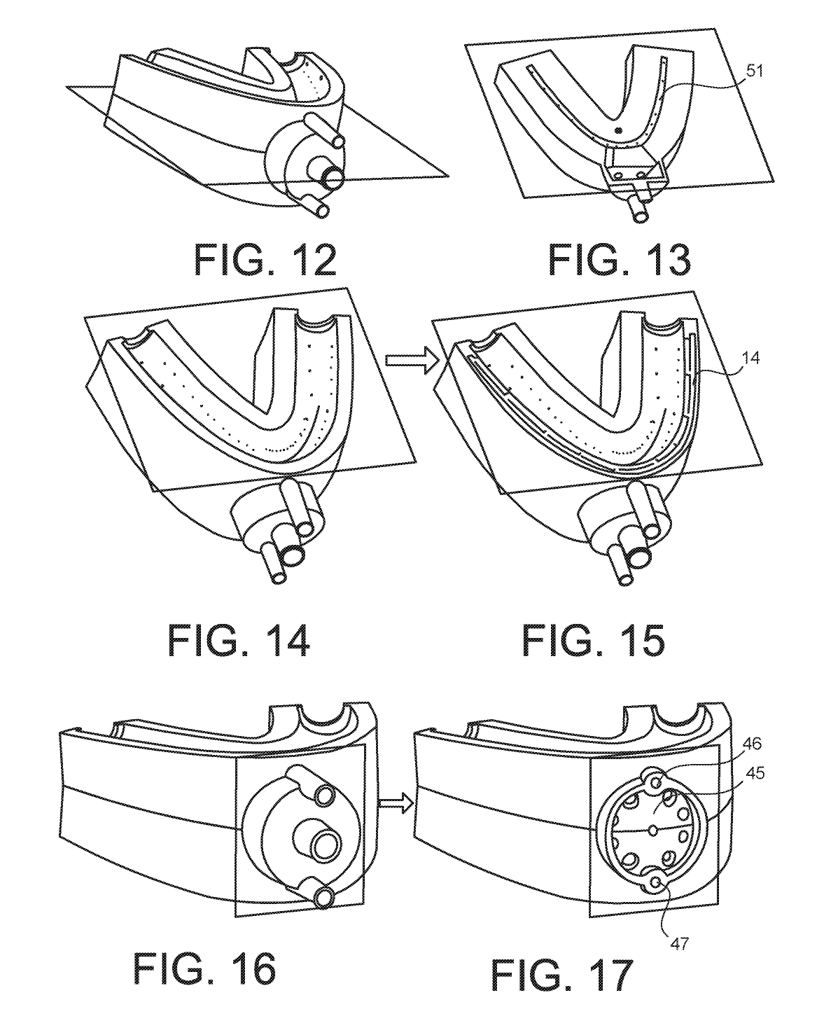

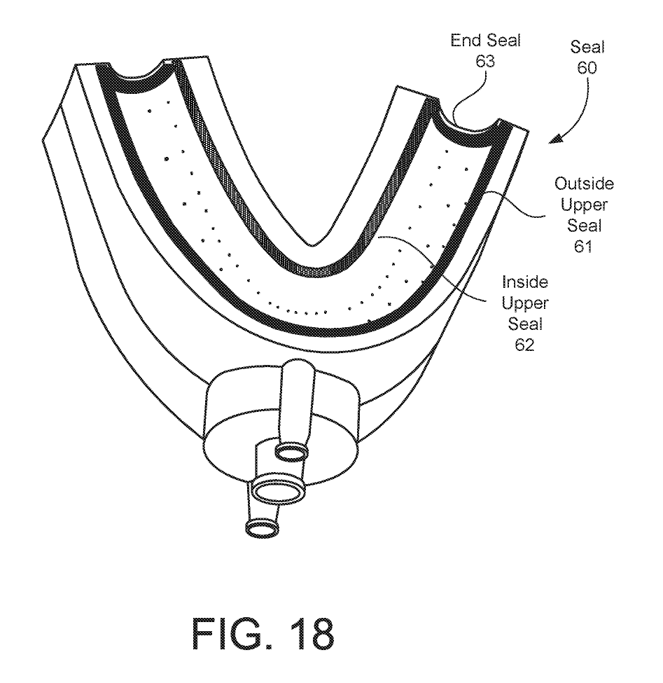

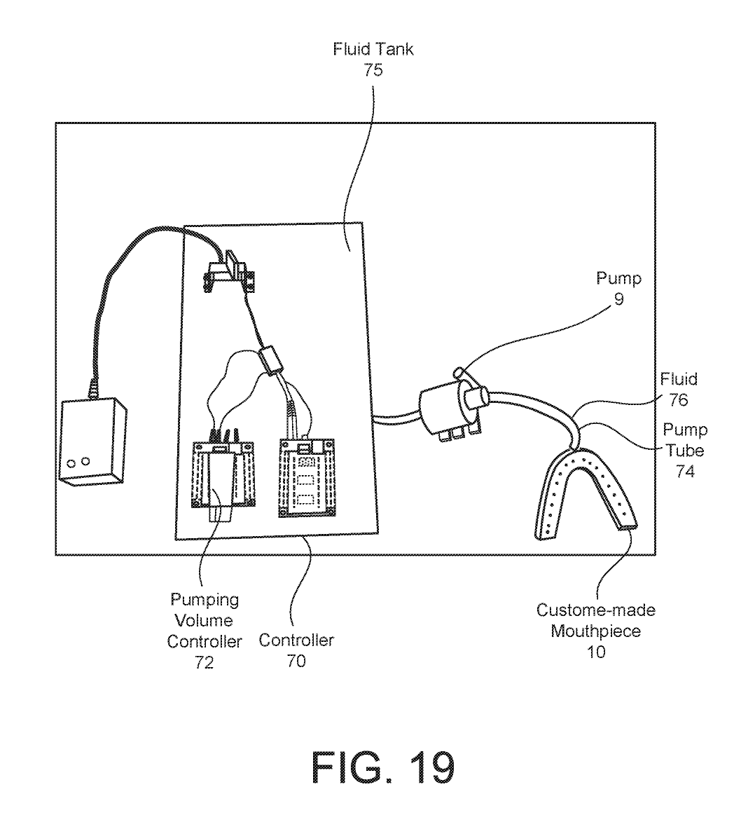

The following call out list of elements can be a useful guide in referencing the element of the drawings.

9 Pump

10 Custom Mouthpiece

11 Dental Target

12 Mouthpiece Body

13 Outside Spray Conduit

14 Outside Exit Conduit

15 Inside Spray Conduit

16 Outside Seal

17 Inside Seal

18 Curved Inside Surface

19 Curved Outside Surface

20 Mouthpiece Inner Surface

21 Outside Spray Conduit Lower Opening Row

22 Outside Spray Conduit Middle Opening Row

23 Outside Spray Conduit Upper Opening Row

24 Outside Exit Conduit Opening

25 Sealed Space

30 Inside Spray Conduit Openings

31 Inside Spray Conduit Bottom Opening

32 Inside Spray Conduit Middle Opening

33 Inside Spray Conduit Top Opening

34 Inside Spray Conduit First Sulcus Opening

35 Inside Spray Conduit Second Sulcus Opening

36 Inside Spray Conduit Third Sulcus Opening

37 Inside Spray Conduit Cusp Opening

40 Manifold

41 Upper Port

42 Distributed Port

43 Lower Port

44 Manifold Chamber

45 Manifold Hollow

46 Upper Tube

47 Lower Tube

51 Spray Conduit

52 Gingiva

60 Seal

61 Outside Upper Seal

62 Inside Upper Seal

63 End Seal

70 Controller

71 Pump On-Off Controller

72 Pumping Volume Controller

73 User Dentition Model

74 Pump Tube

75 Fluid Tank

76 Fluid

77 Upper Portion Of The Dental Target

78 Lower Portion Of The Dental Target

79 Suction Tube

### DETAILED DESCRIPTION OF THE PREFERRED EMBODIMENT

The oral hygiene device has at least the following components: a mouthpiece with irrigation pipes and conduits that are individually designed and fabricated to fit each individual user; a water pump unit providing the fluid the necessary energy to form pressure and pulsation upon hit the tooth surface; a suction unit providing blood pressure suction to remove the fluid from the mouthpiece; a water tank to supply the cleaning fluid; and an electronic control unit to govern the pressure and pulsation of the fluid. Additionally, a seal can be formed as a gasket, or as a deformable elastomeric member to avoid leaking of the mouthpiece.

The mouthpiece is made according to the following steps. In a first step, the mouthpiece is designed in a computer system according to each user's digital dentition models. The user dentition models can be cast in plaster and then scanned to a three-dimensional model, or a user's teeth can be scanned directly. A three-dimensional (3D) digital model of individual's dentitions is first obtained either by digital impressions or by scanning the stone casts of the individual. On the digital model, a customized mouthpiece is designed that contains inlet and outlet pipe system with opening orifices on the inner surface, facing the tooth surfaces. The mouthpiece can be designed using a general Computer-aided Design (CAD) software system or a software system that is specifically developed for the customized mouthpiece design. The 3-D design file is then converted to a printing file for a 3-D printing device. The mouthpiece can be printed in plastic or other materials. Before committing to printing the mouthpiece, a test fit using a virtual user dentition model 73 can be formed.

The design of the mouthpiece is optimized because the process begins when a user receives a dental cast. A dental cast is a soft material that takes a mold of the users teeth. The mold is used to customize the mouthpiece. The dental cast of a users teeth is scanned into the computer as a 3-D model. According to the 3-D model. The water jet spray openings are positioned according to the dental cast so that the water jet spray openings spray the specific locations on the specific user's teeth. The custom mouthpiece is 3-D printed which allows modification of the height, X and Y distances and also the jet spray openings can each have a different size such that the jet spray openings are not all the same size in terms of diameter. The jet spray openings are pressurized by conduits. The conduits can also be sized and moved according to the 3-D model. For example, if a person has a large gap between two teeth, the 3-D model will show the computer and the computer can a large the jet spray opening that sprays the gap between the two teeth. In this way, the person's unique personal trait of a large gap between the two teeth can be cleaned more effectively because the device is adapted to a specific user.

Additionally, the number of openings can be adjusted. For example, if a person has a large gap between two teeth, instead of having several small jet sprays, a single large opening can be positioned to spray through the large gap between the two teeth. Different inlets and outlets can provide multiple zones or sections that are activated sequentially. Sets of tubes can provide flow controlled by a valve or pump controller. Instead of a full mouth, the mouthpiece can also be a partial portion of the mouth such as a quarter portion. The mouthpiece can also clean dentures and can be custom designed for cleaning a particular set of dentures.

A complex piping system is placed inside the mouthpiece. There are two types of piping systems separately imbedded in the mouthpiece: the delivering piping system (inlet) and suction piping system (outlet). The delivering piping system is connected to the water pump unit, and the suction piping system is connected to suction unit. On the inner surface of the mouthpiece, orifices connected to the solution delivering piping system are arranged according to the topography of each individual tooth, to make sure all the plaque accumulate areas (including interproximal areas) are covered by a direct hit and splash areas when the unit is turn on. Relatively bigger orifices connected to the suction tubing system are placed on the areas that plaques are much less likely to accumulate, such as molar functional cusps, incisal edge et al, or any areas that the designer wishes.

The mouthpiece touches the gingival tissue below gingival margin, to form a sealed space between tooth surface and inner surface of the mouthpiece. The inner wall of the mouthpiece is following the natural contour of dentition, but keeps 1-5 mm distance from the tooth surface. The mouthpiece with sealant can be fabricated using multi-material 3D printing. Alternatively, the sealant in soft materials can be fabricated using other fabrication approaches such as injection molding. The fabricated sealant is then assembled with the 3D-printed mouthpiece.

An additional structure named “occlusal stop” can be designed to stabilize the mouthpiece in position. The “occlusal stop” means the inner surface of the mouthpiece is to touch the tooth surface in the desired areas, to provide stability when the mouthpiece is placed in user's mouth. It is recommended to place three “occlusal stops” on each arch of the dentitions, and it should be placed on functional cusps of posterior tooth and anterior incisal edge. Based on user's digital teeth model, a software system can automatically add the structure named “occlusal stop” to the custom-designed mouthpiece. Once the custom-designed mouthpiece model is finalized, a 3-D printer is used to fabricate the mouthpiece. Due to the flexibility of 3D printing processes such as Stereolithography (SLA), mass customized products can be fabricated with reasonable costs. Other dental devices such as Invisialign dental braces have been successfully commercialized. Some physical tests on custom-designed mouthpiece have been performed, which illustrate the feasibility of inlet/outlet piping systems in a 3D-printed object.

The key principle of the invention is to develop an oral hygiene device that is custom-made based on individual's teeth. Thus, for each individual user, the mouthpiece will be slightly difference, with both customized contours and orifice designs including their positions and opening angles. The preferred embodiment is shown with the aforementioned drawings. The invention, however, is not intend to be only limited to the embodiment set forth herein. Rather, this embodiment is provided so that the principle of the device will be thoroughly and completely understood. This invention allows the designer of the mouthpiece to input his/her own desire of plaque control for the user. The designer should be a person with certain degree of dental professional knowledge. The 3-D printed mouthpiece preferably has rounded junctions in the conduits for providing a consistent, strong flow from both nozzles.

A pump 9 provides a flow of water to a custom mouthpiece 10. The custom mouthpiece 10 direct water toward a dental target 11. The dental target 11 can be a users teeth and gums or dentures. The mouthpiece body 12 is really printed from a 3-D printer file generated from a CAD program. The mouthpiece body 12 has a curved outside surface 19 and a curved inside service 18. The mouthpiece body 12 is formed with an outside spray conduit 13, and an inside spray conduit 15. The outside exit conduit 14 is also formed on the mouthpiece body 12 between the outside spray conduit 13 and the inside spray conduit 15. An outside seal 16 and an inside seal 17 conform to gums of the dental target 11.

The outside spray conduit 13 pressurizes an outside spray conduit opening row which includes an outside spray conduit lower opening row 21, an outside spray conduit middle opening row 22, and an outside spray conduit upper opening row 23. The outside exit conduit 14 preferably includes a larger outside exit conduit opening for suctioning splashed water and maintaining water flow. The inside spray conduit 15 pressurizes a set of vertically arranged openings arranged to spray an inside surface of the dental target 11. The inside spray conduit openings include an inside spray conduit bottom opening 31, an inside spray conduit middle opening 32, and an inside spray conduit top opening 33.

The inside spray conduit 15 also has a horizontally arranged set of openings that spray the top portion of the tooth. The inside spray conduit 15 pressurizes a plurality of sulcus openings including an inside spray conduit first sulcus opening 34, an inside spray conduit second sulcus opening 35, and a inside spray conduit third sulcus opening 36. The inside spray conduit cusp opening 37 sprays a cusp.

The spray conduit are pressurized by a manifold 40. The manifold 40 is pressurized by a distributed port 42. The distributed port 42 can be placed between an upper port 41 and lower port 43. The manifold 40 can protrude from the curved outside surface 19 of the custom mouthpiece 10. The manifold chamber 44 is hollow and distributes liquid into the mouthpiece 10 via a plurality of spray conduits 51. An upper tube 46 preferably extends from the upper port 41 and a lower tube 47 preferably extends from the lower port 43. The upper tube 46 can be a suction tube, or the lower tube 47 can be a suction tube.

The seal system 60 generally includes the inside seal 17 and the outside seal 16, which can be formed as an inside upper seal 62, and an outside upper seal 61. Preferably, an end seal 63 is included for minimizing leakage. The seals can be elastomeric or a putty material that hardens over time. The seals provide a sealed space 25 against the gingiva tissue 52. The end seal 63 can be an occlusal stop for stabilizing the mouthpiece.

The pump 9 is generally controlled by a controller 70 which includes a pump in volume controller 72 and a pump on-off controller 71. The pump pumps fluid 76 from a fluid tank 75 through a pump tube 74 into the mouthpiece body 12 via the manifold chamber 44. The controller 70 can be an electronic control unit that is low-voltage powered.

The mouthpiece can be designed in one piece to cover both upper and lower dentitions, or can be designed in two pieces to cover the upper and lower dentitions separately. The upper portion of the dental target 77 and the lower portion of the dental target 78.

1. A custom dental irrigation device comprising:
a user dentition model;
a custom made mouthpiece made according to the user dentition model, wherein the custom made mouthpiece is configured to deliver fluid to a dental target while removing used irrigation fluid;
a pump configured to pump fluid to the mouthpiece;
a suction pump configured to remove fluid from the mouthpiece;
a fluid tank; and
a controller.

2. The custom dental irrigation device of claim 1, wherein the mouthpiece is fabricated with 3-D print techniques.

3. The custom dental irrigation device of claim 2, wherein the mouthpiece is designed in two pieces to cover an upper portion of a dental target and a lower portion of a dental target separately.

4. The custom dental irrigation device of claim 2, wherein the mouthpiece has an inner surface following the shape of the user dentition model, wherein the inner surface touches the gingiva tissue to form a sealed space once the mouthpiece is set in a user's mouth, whereby fluid is delivered to the dental target, and removed from the sealed space.

5. The custom dental irrigation device of claim 2, further comprising an occlusal stop formed on an inner surface of the mouthpiece to stabilize the mouthpiece.

6. The custom dental irrigation device of claim 2, wherein the mouthpiece has a pump tube for delivering fluid and a suction tube for removing fluid, wherein the pump tube is connected to a manifold chamber having a manifold hollow.

7. The custom dental irrigation device of claim 2, wherein the mouthpiece has an outside spray conduit delivering water to a sealed space, wherein the mouthpiece has an inside spray conduit delivering water to the sealed space, wherein the mouthpiece has an outside exit conduit between the inside spray conduit and the outside spray conduit, wherein the outside exit conduit is configured for removing water from the sealed space.

8. The custom dental irrigation device of claim 7, further including a plurality of inside spray conduit openings formed in fluid communication with the inside spray conduit including: an inside spray conduit bottom opening; an inside spray conduit middle opening; and an inside spray conduit top opening, wherein the plurality of inside spray conduit openings are disposed on a generally vertical inner surface of the mouthpiece body.

9. The custom dental irrigation device of claim 7, further including a plurality of inside spray conduit openings formed in fluid communication with the inside spray conduit including: an inside spray conduit first sulcus opening, and inside spray conduit second sulcus opening, an inside spray conduit third sulcus opening, and an inside spray conduit cusp opening.

10. The custom dental irrigation device of claim 7, further including a plurality of outside spray conduit openings formed in fluid communication with the outside spray conduit, and disposed on a generally vertical inner surface of the mouthpiece body, wherein the plurality of outside spray conduits include: an outside spray conduit lower opening row; an outside spray conduit middle opening row; and an outside spray conduit upper opening row.

11. A method for irrigating a dental target comprising the steps of:
deriving a user dentition model from a dental target, wherein the user dentition model is a three-dimensional (3D) model of the dental target;
forming a customized mouthpiece for the individual using the user dentition model, wherein the customized mouthpiece has a pump tube for delivering fluid and a suction tube for removing fluid, wherein the pump tube is connected to a manifold chamber having a manifold hollow, wherein the opening orifices are based on topographies of the teeth represented in the user dentition model;
printing the customized mouthpiece on a 3-D printer.

12. The method for irrigating a dental target of claim 11, further including the step of obtaining the user dentition model by taking digital impressions of the dental target.

13. The method for irrigating a dental target of claim 11, further including the step of obtaining the user and dentition model by taking plaster casts of the dental target.

14. The method for irrigating a dental target of claim 11, wherein the customized mouthpiece has an outside exit conduit formed at a cusp of the user dentition model, wherein the outside exit conduit is formed between an outside spray conduit and an inside spray conduit, wherein the outside exit conduit has an outside exit conduit opening formed proximate to a cusp of the user dentition model.

15. The method for irrigating a dental target of claim 11, wherein the customized mouthpiece has an outside exit conduit formed at an incisal edge of the user dentition model, wherein the outside exit conduit is formed between an outside spray conduit and an inside spray conduit.

16. The method for irrigating a dental target of claim 11, wherein the customized mouthpiece further includes at least one occlusal stop.

17. The method of claim 11, wherein placing the occlusal stops comprises: placing at least one occlusal stop on a functional cusp of a posterior tooth of the dentition model; and
placing at least one occlusal stop on an anterior incisal edge of a tooth of the dentition model.

18. The method of claim 11, wherein placing the occlusal stops is performed automatically by software based on the user dentition model.

19. The method of claim 11, wherein the 3-D printer is a Stereolithography (SLA) 3D printer.
